(19) United States
(12) Patent Application Publication
(10) Pub. No.: US 2018/0309403 A1
(43) Pub. Date: Oct. 25, 2018

(54) Temporary Structure Assembly

(71) Applicant: Debbie Brown, Brampton (CA)

(72) Inventor: Debbie Brown, Brampton (CA)

(21) Appl. No.: 15/492,075

(22) Filed: Apr. 20, 2017

(51) Int. Cl. H02S 20/22; H02S 40/38; H02S 40/32; E04H 15/10; E04B 1/32

(52) U.S. Cl. CPC H02S 20/22; H02S 40/38; E04B 1/32; E04H 15/10; H02S 40/32

(57) ABSTRACT

A temporary structure assembly for covering a construction site and providing electrical power includes a dome that may be erected on a support surface thereby facilitating the dome to cover a construction site. A solar array is coupled to the dome and the solar array is configured to be exposed to sunlight. In this way the solar array converts the sunlight into electrical energy. A selected number of electrical appliances are each electrically coupled to the solar array to power the selected electrical appliances within the dome.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to structure devices and more particularly pertains to a new structure device for covering a construction site and providing electrical power.

### BRIEF SUMMARY OF THE INVENTION

An embodiment of the disclosure meets the needs presented above by generally comprising a dome that may be erected on a support surface thereby facilitating the dome to cover a construction site. A solar array is coupled to the dome and the solar array is configured to be exposed to sunlight. In this way the solar array converts the sunlight into electrical energy. A selected number of electrical appliances are each electrically coupled to the solar array to power the selected electrical appliances within the dome.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a temporary structure assembly according to an embodiment of the disclosure.

FIG. 2 is a top phantom view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a perspective view of an alternative embodiment of the disclosure.

FIG. 6 is a top view of an alternative embodiment of the disclosure.

### DETAILED DESCRIPTION OF THE INVENTION

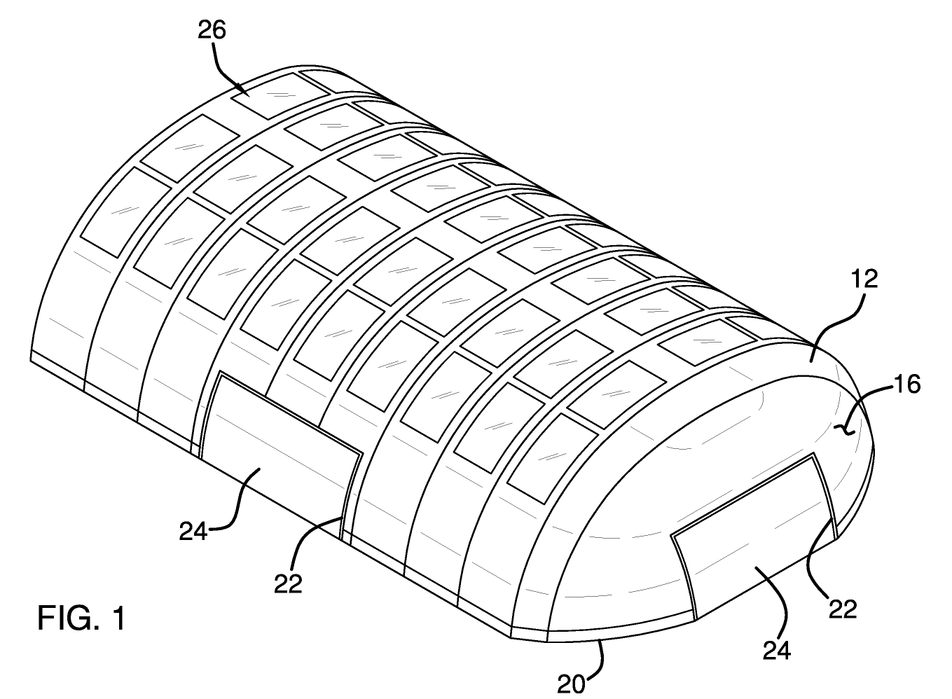

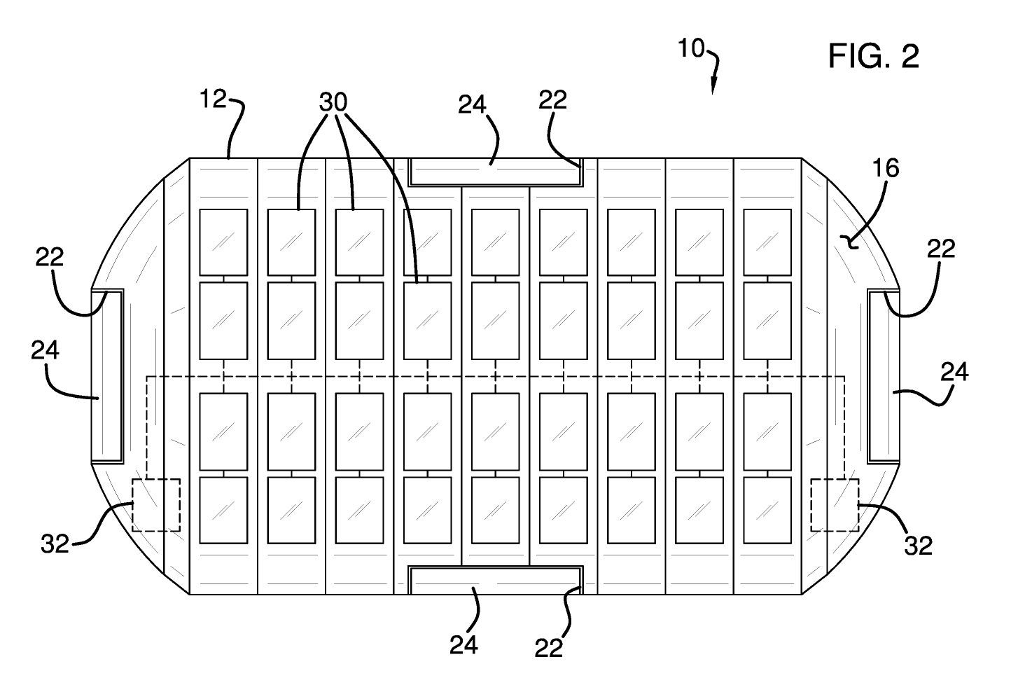

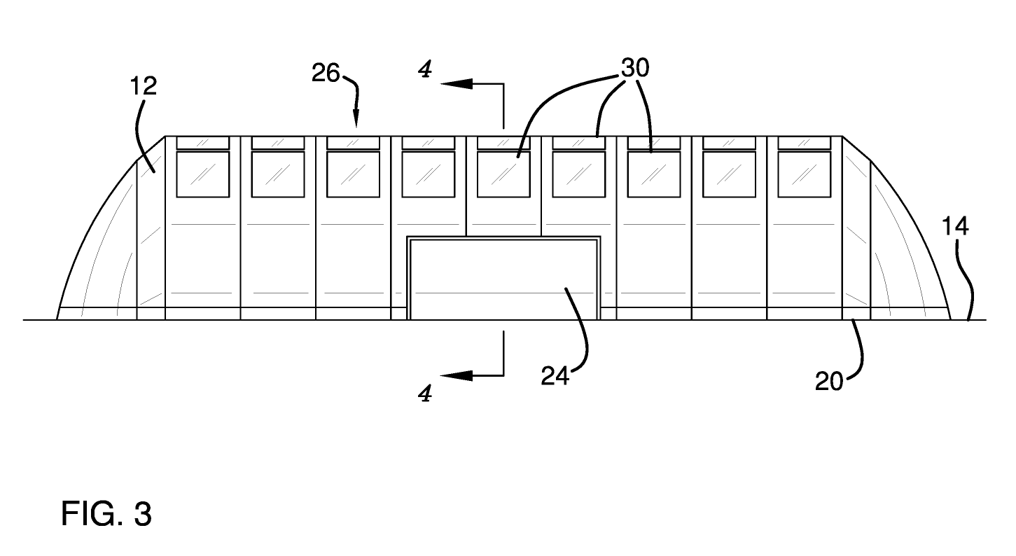

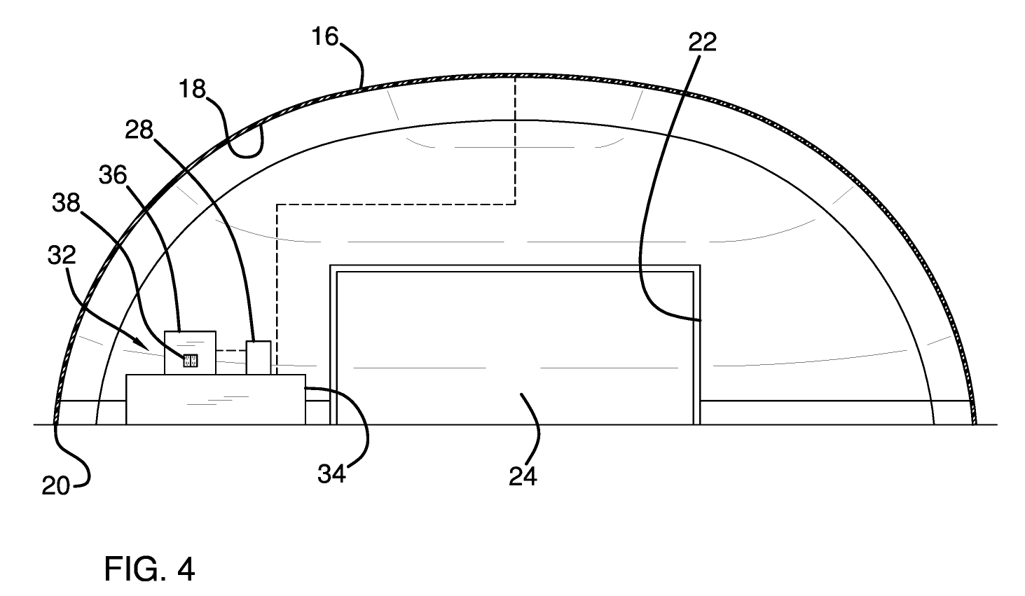

With reference now to the drawings, and in particular to FIGS. 1 through 6 thereof, a new structure device embodying the principles and concepts of an embodiment of the disclosure and generally designated by the reference numeral 10 will be described.

As best illustrated in FIGS. 1 through 6, the temporary structure assembly 10 generally comprises a dome 12 that is selectively erected on a support surface 14 thereby facilitating the dome 12 to cover a construction site. The support surface 14 may be ground and the construction site may be a commercial construction site, a residential construction site and an industrial construction site. The dome 12 has an outer surface 16, an inner surface 18 and a perimeter edge 20 extending therebetween. Each of the outer 16 and inner 18 surfaces is concavely arcuate with respect to the perimeter edge 20. Moreover, the perimeter edge 20 is positioned on the support surface 14 having the dome 12 extending upwardly from the support surface 14.

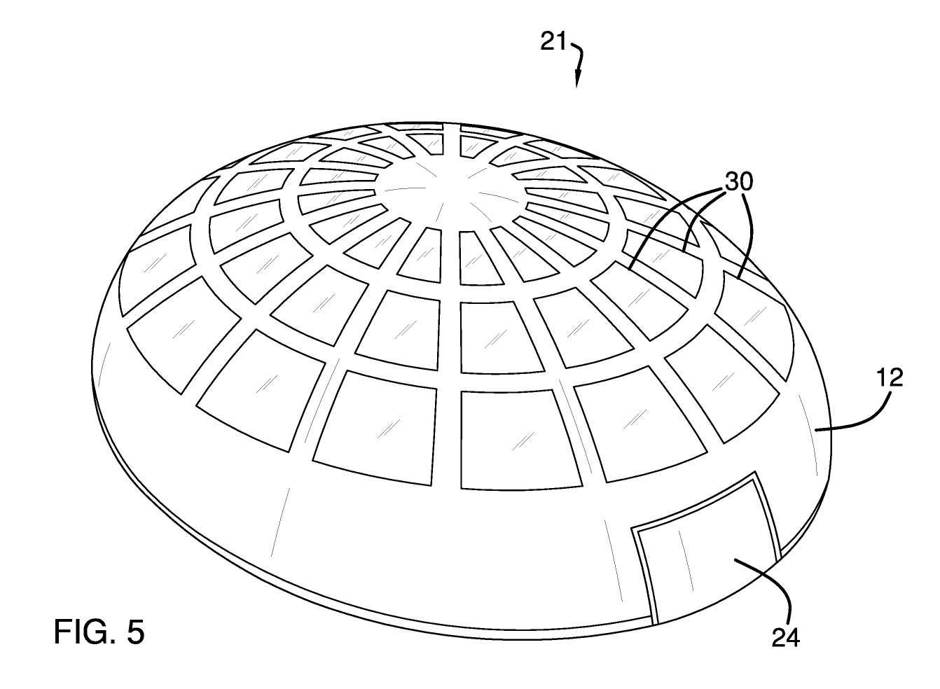

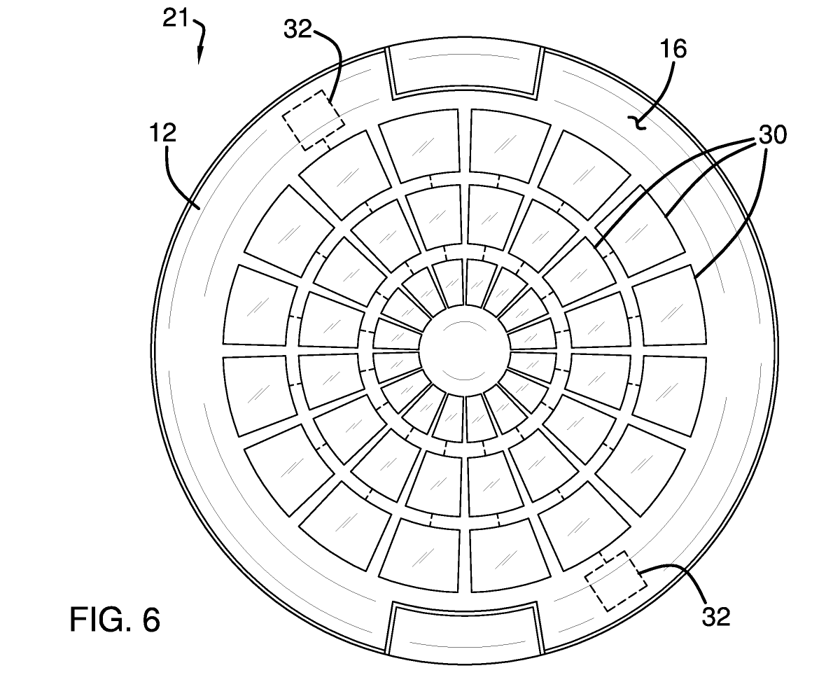

The dome 12 may have a length and a width that is sufficient to encompass an outer perimeter of the construction site. The dome 12 may have a height that is sufficient to accommodate the construction of multiple story buildings, elevated industrial structures and any other high rise, structural components. Additionally, the dome 12 may be longitudinally elongated such that the dome 12 has an ovoid shape. In an alternative embodiment 21 as shown in FIGS. 5 and 6, the peripheral edge of the dome 12 may be continuous such that the dome 12 has a hemispherical shape.

The dome 12 is comprised of a deformable material such as a vinyl coated, polyester fabric or other deformable material. Additionally, the dome 12 is comprised of a fluid impermeable material such that the dome 12 protects the construction site from precipitation and other sources of liquid. The dome 12 may additionally be comprised of an Ultraviolet radiation reflecting material thereby protecting the construction site from Ultraviolet radiation. The dome 12 may include a frame that is selectively erected around the construction site to support the dome 12. The frame may be any modular, structural frame employed in the convention of dome construction. The dome 12 may be attached to the frame through any conventional means to include, but not be limited to, clamps, fasteners, ties or any combination thereof. Additionally, the dome 12 may include retention cables and anchors for securing the dome 12 to the support surface 14.

The dome 12 has a plurality of openings 22 and each of the openings 22 extends through the outer surface 16 and the inner surface 18. Thus, each of the openings 22 facilitates entry into the dome 12 and exit from the dome 12. Each of the openings 22 extends upwardly from the perimeter edge 20 and the openings 22 are spaced apart from each other and are distributed around the dome 12. Moreover, each of the openings 22 may have a height of at least 3.0 meters to accommodate large construction equipment to pass through the openings 22.

A plurality of doors 24 is provided and each of the doors 24 is movably coupled to the dome 12. Each of the doors 24 is aligned within an associated one of the openings 22 such that each of the doors 24 selectively opens and closes the associated opening 22. Each of the doors 24 may be movably coupled to the dome 12 through any conventional mechanical means to include, but not be limited to, rails, hinges or any combination thereof.

A solar array 26 is provided and the solar array 26 is coupled to the dome 12. In this way the solar array 26 is exposed to sunlight thereby facilitating the solar array 26 to convert the sunlight into electrical energy. A selected number and type of electrical appliances 28 are each selectively electrically coupled to the solar array 26 to power the selected electrical appliances 28. The selected electrical appliances 28 may include, but not be limited to, electrical construction equipment, heating equipment and cooling equipment. The heating equipment may be any type of heating equipment to heat an interior of the dome 12 during winter months. Additionally, the cooling equipment may be any type of cooling equipment to cool the interior of the dome 12 during summer months.

The solar array 26 comprises a plurality of solar panels 30 and each of the solar panels 30 is coupled to the outer surface 16 of the dome 12. The solar panels 30 are spaced apart from each other and are distributed on the dome 12. The plurality of solar panels 30 may be in electrical communication with each other. Additionally, each of the solar panels 30 may be solar panels of any conventional design to include, but not be limited to, flexible solar panels and rigid solar panels.

A plurality of power supplies 32 is provided and each of the power supplies 32 is positioned within the dome 12. Each of the power supplies 32 is electrically coupled to the plurality of solar panels 30. In this way each of the power supplies 32 receives the electrical energy from the solar panels 30. The selected electrical appliances 28 are selectively and electrically coupled to the power supplies 32.

Each of the power supplies 32 comprises at least one battery 34 that is positioned within the dome 12. The at least one battery 34 corresponding to each of the power supplies 32 may be coupled to the frame that supports the dome 12. The at least one battery 34 is electrically coupled to the plurality of solar panels 30 such that the plurality of solar panels 30 charges the at least one battery 34. Moreover, the at least one battery 34 may be a rechargeable battery of any conventional design generally employed in the storage of solar power.

Each of the power supplies includes an inverter 36 and the inverter is positioned within the dome 12. The inverter 36 corresponding to each of the inverters 36 may be coupled to the frame that supports the dome 12. The inverter 36 is electrically coupled to the battery 34 to convert DC current into AC current. The inverter 36 includes a plurality of female electrical outlets 38 and each of the female electrical outlets 38 receives the AC current. The selected electrical appliances 28 are selectively plugged into a selected one of the female electrical outlets 38 for electrical power.

In use, the dome 12 is erected to surround the construction site and the dome 12 is constructed through any conventional means with respect to the construction of domes that are comprised of a deformable material. In this way the construction site is shielded from precipitation and other elements of weather, such as wind and the like. Each of the doors 24 is selectively opened to facilitate entry and egress with respect to the dome 12. The selected electrical appliances 28 are plugged into the inverter 36 of an associated one of the power supplies 32. In this way the selected electrical appliances 28 are powered inside of the dome 12 without the need for an extrinsic power source with respect to the dome 12. All aspects of construction are carried out within the dome 12 and the dome 12 is dissembled and removed from the construction site upon completion of the construction. Any selected means of lighting the interior of the dome 12 is employed and the means of lighting the interior of the dome 12 are powered with the power supplies 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A temporary structure assembly being configured to be erected over a construction site thereby controlling environmental conditions of the construction site, said assembly comprising:
a dome being configured to be erected on a support surface thereby facilitating said dome to cover a construction site, said dome has an outer surface, an inner surface and a perimeter edge extending therebetween, said inner surface being concavely arcuate with respect to said perimeter edge, an entirety of said outer surface being continuously convexly arcuate with respect to said perimeter edge, said perimeter edge being configured to be positioned on the support surface having said dome extending upwardly from the support surface; and
a solar array being coupled to said dome wherein said solar array is configured to be exposed to sunlight thereby facilitating said solar array to convert the sunlight into electrical energy, said solar array being configured to have selected electrical appliances being electrically coupled to said solar array to power the selected electrical appliances.

2. (canceled)

3. The assembly according to claim 1, wherein said dome has a plurality of openings, each of said openings extending through said outer surface and said inner surface wherein each of said openings is configured to facilitate entry into said dome and exit from said dome, each of said openings extending upwardly from said perimeter edge, said openings being spaced apart from each other and being distributed around said dome.

4. The assembly according to claim 3, further comprising a plurality of doors, each of said doors being movably coupled to said dome, each of said doors being aligned within an associated one of said openings such that each of said doors selectively opens and closes said associated opening.

5. The assembly according to claim 1, wherein said solar array comprises a plurality of solar panels, each of said solar panels being coupled to said outer surface of said dome, said solar panels being spaced apart from each other and being distributed on said dome.

6. The assembly according to claim 5, further comprising a plurality of power supplies, each of said power supplies being coupled to said inner surface of said dome, each of said power supplies being electrically coupled to said plurality of solar panels such that each of said power supplies receives the electrical energy from said solar panels, each of said power supplies being configured to have the selected electrical appliances being electrically coupled thereto.

7. The assembly according to claim 6, wherein each of said power supplies comprises at least one battery being coupled to said dome, said at least one battery being electrically coupled to said plurality of solar panels such that said plurality of solar panels charges said at least one battery.

8. The assembly according to claim 7, further comprising an inverter being coupled to said dome, said inverter being electrically coupled to said battery wherein said inverter is configured to convert DC current into AC current, said inverter being configured to have the selected electrical appliances being electrically coupled thereto.

9. A temporary structure assembly being configured to be erected over a construction site thereby controlling environmental conditions of the construction site, said assembly comprising:
a dome being configured to be erected on a support surface thereby facilitating said dome to cover a construction site, said dome having an outer surface, an inner surface and a perimeter edge extending therebetween, said inner surface being concavely arcuate with respect to said perimeter edge, an entirety of said outer surface being continuously convexly arcuate with respect to said perimeter edge, said perimeter edge being configured to be positioned on the support surface having said dome extending upwardly from the support surface, said dome having a plurality of openings, each of said openings extending through said outer surface and said inner surface wherein each of said openings is configured to facilitate entry into said dome and exit from said dome, each of said openings extending upwardly from said perimeter edge, said openings being spaced apart from each other and being distributed around said dome;
a plurality of doors, each of said doors being movably coupled to said dome, each of said doors being aligned within an associated one of said openings such that each of said doors selectively opens and closes said associated opening; and
a solar array being coupled to said dome wherein said solar array is configured to be exposed to sunlight thereby facilitating said solar array to convert the sunlight into electrical energy, said solar array being configured to have selected electrical appliances being electrically coupled to said solar array to power the selected electrical appliances, said solar array comprising:
a plurality of solar panels, each of said solar panels being coupled to said outer surface of said dome, said solar panels being spaced apart from each other and being distributed on said dome, and
a plurality of power supplies, each of said power supplies being coupled to said inner surface of said dome, each of said power supplies being electrically coupled to said plurality of solar panels such that each of said power supplies receives the electrical energy from said solar panels, each of said power supplies being configured to have the selected electrical appliances being electrically coupled thereto, each of said power supplies comprising:
at least one battery being coupled to said dome, said at least one battery being electrically coupled to said plurality of solar panels such that said plurality of solar panels charges said at least one battery, and
an inverter being coupled to said dome, said inverter being electrically coupled to said battery wherein said inverter is configured to convert DC current into AC current, said inverter being configured to have the selected electrical appliances being electrically coupled thereto.
